(19) United States
(12) Patent Application Publication
(10) Pub. No.: US 2007/0081122 A1
(43) Pub. Date: Apr. 12, 2007

(54) Structure of an eyeglasses lamp

(76) Inventor: Chih-Hung Huang, Tainan County (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/247,381

(22) Filed: Oct. 12, 2005

(51) Int. Cl. G02C 1/00

(52) U.S. Cl. 351/158

(57) ABSTRACT

An eyeglasses lamp includes a fixed seat member, a movable support member, and a lamp; the fixed seat member has a connecting part joined to an eyeglasses temple; the fixed seat member has a hollow pivotal part projecting from the connecting part thereof; the movable support member is fitted in and pivoted to the hollow pivotal part of the fixed seat member at a pivotal portion thereof such that it can be angularly moved to various orientations in relation to the fixed seat member; the movable support member has a fastening part joined to the pivotal portion thereof; the lamp is fastened to the fastening part of the movable support member.

### BACKGROUND OF THE INVENTION

1. Field of the Invention

The present invention relates to an eyeglasses lamp, more particularly one, which is structured in such a way as to be angularly adjustable to various orientations, thus ensuring that light emitted from it will travel onto the articles, towards which the eyeglasses wearer's line of sight is directed.

2. Brief Description of the Prior Art

In order for people to see clearly when they are doing a piece of work such as repair in a place without enough illumination, portable lighting devices such as flashlights are available. However, flashlight users have to hold the flashlights with one hand, and in turn they have only one free hand to do their work. Therefore, helmets with lamps and eyeglasses with lamps are available, which allow the users to have two hands free for doing their work.

Referring to FIGS. 5 and 6, a conventional eyeglasses lamp includes a support member 42, and a shining member 43; the support member 42 is joined to an eyeglasses temple 41 in an up-and-down pivotal manner; the shining member 43 is held in the support member 42. Therefore, the eyeglasses wearer is allowed to pivot the support member 42 up or down such that light emitted from the shining member 43 will travel right onto an article in front of him.

However, the lamp can't be leftwards or rightwards angularly moved relative to the eyeglasses temple 41, and in turn light emitted from shining member 43 can't be in the same direction as the eyeglasses wearer's line of view if the wearer looks to the left or the right. Therefore, the lamp isn't very convenient to use.

### SUMMARY OF THE INVENTION

It is a main object of the invention to provide an improvement on an eyeglasses lamp to overcome the above-mentioned problem. The eyeglasses lamp of the present invention includes a fixed seat member, a movable support member, and a lamp. The fixed seat member has a connecting part joined to an eyeglasses temple, and a hollow pivotal part projecting from the connecting part thereof. The lamp is fastened to a fastening part of the movable support member. The movable support member is fitted in and pivoted to the hollow pivotal part of the fixed seat member at a pivotal portion thereof such that it can be angularly adjusted to various orientations in relation to the fixed seat member, thus ensuring that light emitted from the lamp will travel onto the articles, towards which the eyeglasses wearer's line of sight is directed.

### BRIEF DESCRIPTION OF THE DRAWINGS

The present invention will be better understood by referring to the accompanying drawings, wherein:

FIG. 1 is an exploded perspective view of the first preferred embodiment of an eyeglasses lamp in the present invention,

FIG. 2 is a sectional view of the first preferred embodiment,

FIG. 3 is an exploded perspective view of the second embodiment,

FIG. 4 is an exploded perspective view of the third embodiment,

FIG. 5 is a view of the conventional eyeglasses lamp, and

FIG. 6 is a view of the conventional eyeglasses lamp in use.

### DETAILED DESCRIPTION OF THE PREFERRED EMBODIMENTS

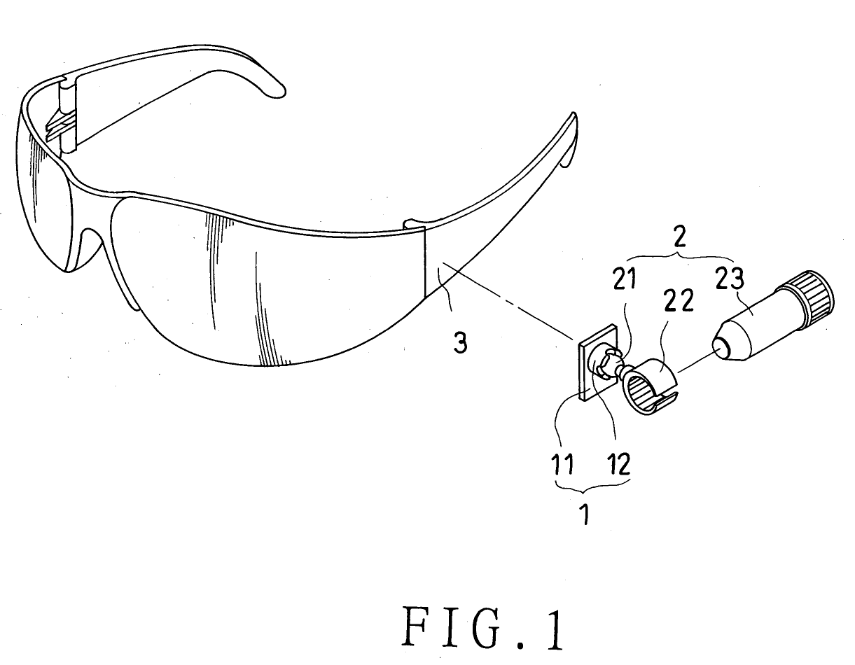

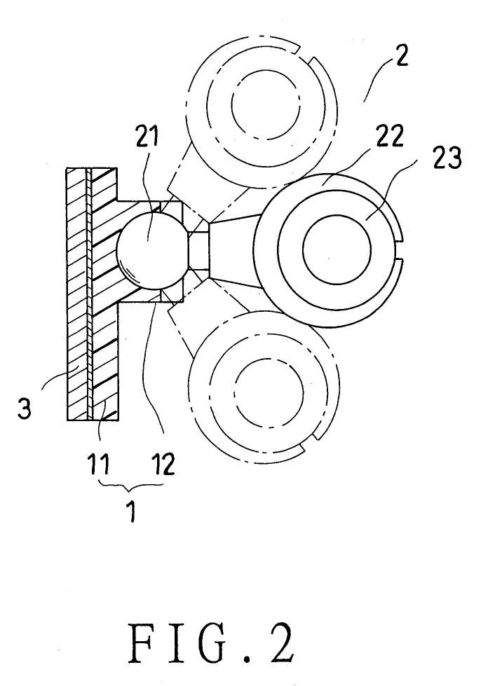

Referring to FIGS. 1 and 2, a first preferred embodiment of an eyeglasses lamp includes a fixed seat member 1, a movable support member 2, and a lamp 23.

The fixed seat member 1 includes a connecting part 11, and a hollow pivotal part 12 projecting from the connecting part 11. The fixed seat member 1 is securely adhered to an eyeglasses temple 3 at the connecting part 11 thereof.

The movable support member 2 includes a pivotal portion 21, and a fastening part 22 joined to the pivotal portion 21. The movable support member 2 is fitted in and pivoted to the hollow pivotal part 12 of the fixed seat member 1 at the pivotal portion 21 thereof. And, the lamp 23 is connected to the fastening part 22 of the movable support member 2. Therefore, the lamp 23 can be adjusted in orientation such that light emitted from the lamp 23 will be in the same direction as the eyeglasses wearer's line of view, and enough illumination is provided to the wearer for her/him to see the articles clearly, towards which her/his line of view is directed.

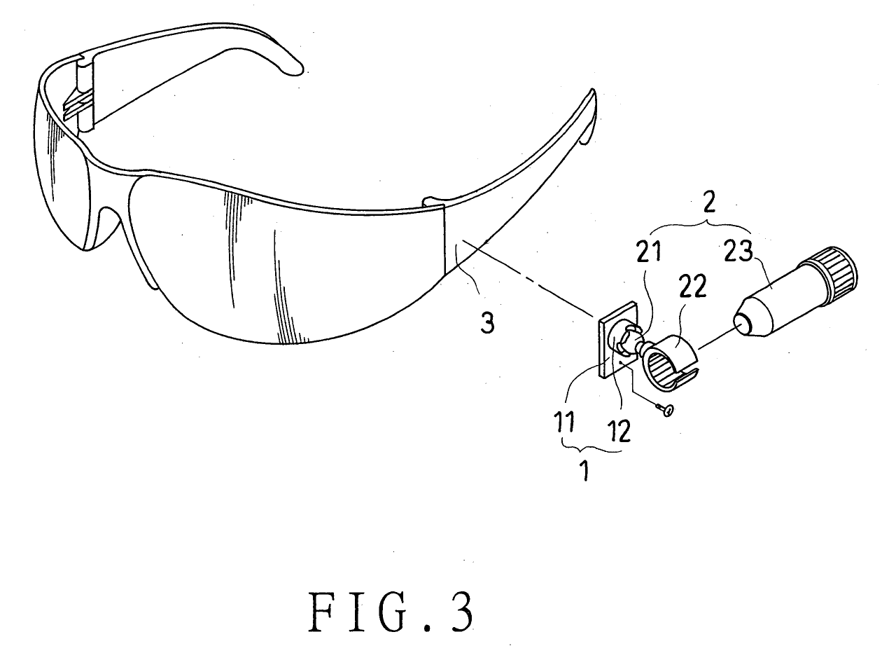

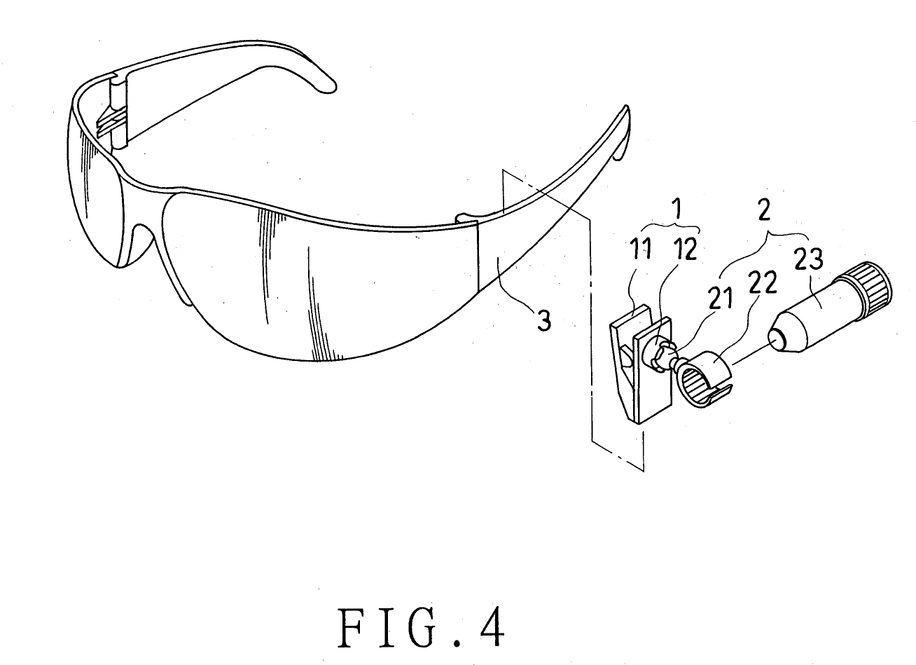

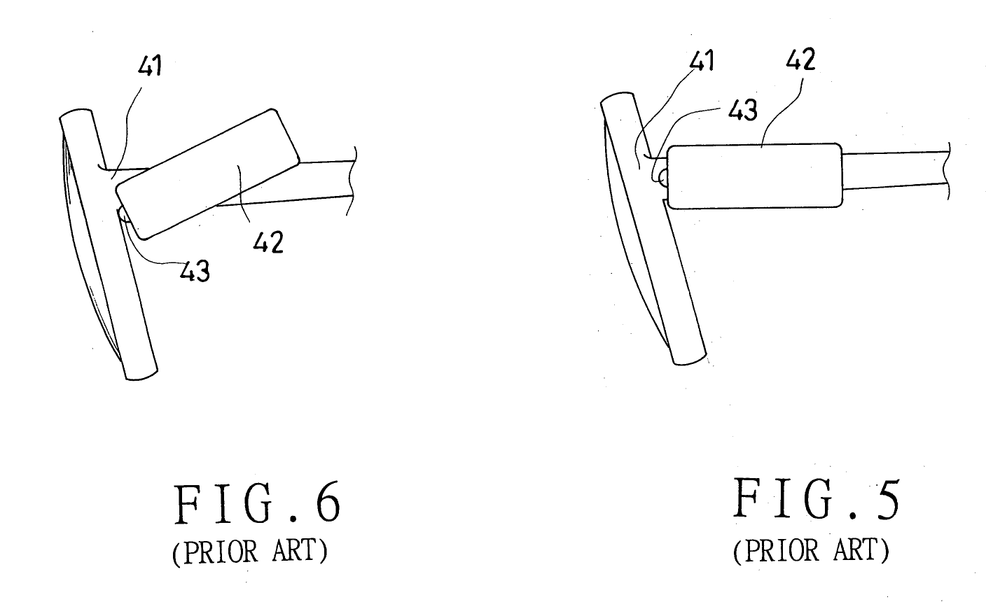

Referring to FIG. 3, in a second preferred embodiment of the present invention, the fixed seat member 1 is securely joined to the eyeglasses temple 3 at the connecting part 11 by means of screws. And referring to FIG. 4, in a third preferred embodiment of the present invention, the connecting part 11 of the fixed seat member 1 is a clip, and the fixed seat member 1 is fastened to the eyeglasses temple 3 by means of the connecting part 11.

When comparing the eyeglasses lamp of the present invention to the conventional one, which can only be upwards and downwards angularly adjusted, it can be seen that the eyeglasses lamp of the present invention is more convenient to use because not only can it be up and down angularly moved, it can be left and right angularly adjusted as well, thus ensuring that light emitted from it will travel onto the articles, towards which the eyeglasses wearer's line of sight is directed.

1. Structure of an eyeglasses lamp, comprising:
a fixed seat member; the fixed seat member having a connecting part; the fixed seat member being joined to an eyeglasses temple at the connecting part thereof; the fixed seat member having a hollow pivotal part projecting from the connecting part thereof, the hollow pivotal part having a plurality of recesses formed in a perimeter portion thereof, each of the recesses being angularly spaced one from another;
a movable support member; the movable support member having a pivotal portion; the movable support member being fitted in the hollow pivotal part of the fixed seat member at the pivotal portion thereof; the movable support member having a fastening part joined to the pivotal portion thereof, the pivotal portion being adapted to be received in a selected one of the plurality of recesses in the hollow pivotal part; and
a lamp fastened to the fastening part of the movable support member; the movable support member being angularly movable relative to the fixed seat member for allowing orientation adjustment of the lamp.

2. The eyeglasses lamp structure as claimed in claim 1, wherein the fixed seat member is adhered to the eyeglasses temple.

3. The eyeglasses lamp structure as claimed in claim 1, wherein the fixed seat member is joined to the eyeglasses temple by screws.

4. The eyeglasses lamp structure as claimed in claim 1, wherein the connecting part of the fixed seat member is a clip, and the fixed seat member is fastened to the eyeglasses temple by means of the connecting part thereof.
